(19) United States
(12) Patent Application Publication
(10) Pub. No.: US 2006/0132426 A1
(43) Pub. Date: Jun. 22, 2006

(54) Driving an electrophoretic display

(75) Inventor: Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/542,982

(22) PCT Filed: Jan. 13, 2004
(86) PCT No.: PCT/IB04/50011

§ 371 Date: Jul. 21, 2005

Related U.S. Application Data
(63) Continuation-in-part of application No. PCT/IB03/02342, filed on May 27, 2003.

(30) Foreign Application Priority Data
Jan. 23, 2003 (EP) 03100133.2
Sep. 1, 2003 (EP) 03103262.6

(51) Int. Cl. G09G 3/34

(52) U.S. Cl. 345/107

(57) ABSTRACT

A drive circuit for an electrophoretic matrix display comprises a select driver (16) for selecting lines of pixels (18) of the matrix display. A data driver (10) supplies drive voltage waveforms (VD) to each one of the selected pixels (18) via data electrodes (5, 5′). A controller (15) controls the select driver (16) to select a group of lines of pixels (18) at a same time during portions of the drive voltage waveforms (VD) which for each of the data electrodes (5, 5′) are equal for at least all the pixels (18) which are associated with the same one of the data electrodes (5, 5′).

### FIELD OF THE INVENTION

The invention relates to a drive circuit for an electrophoretic display, an electrophoretic display, a display apparatus comprising such an electrophoretic display, and a method of driving an electrophoretic display.

Electrophoretic displays are used in, for example, electronic books, mobile telephones, personal digital assistants, laptop computers, and monitors.

### BACKGROUND OF THE INVENTION

A display device of the type mentioned in the opening paragraph is known from international patent application WO 99/53373. This patent application discloses an electronic ink display which comprises two substrates, one of which is transparent, the other substrate is provided with electrodes arranged in rows and columns. Display elements or pixels are associated with intersections of the row and column electrodes. Each display element is coupled to the column electrode via a main electrode of a thin-film transistor (further referred to as TFT). A gate of the TFT is coupled to the row electrode. This arrangement of display elements, TFT's and row and column electrodes jointly forms an active matrix display device.

Each pixel comprises a pixel electrode which is the electrode of the pixel which is connected via the TFT to the column electrodes. During an image update period or image refresh period, a row driver is controlled to select all the rows of display elements one by one, and the column driver is controlled to supply data signals in parallel to the selected row of display elements via the column electrodes and the TFT's. The data signals correspond to image data to be displayed.

Furthermore, an electronic ink is provided between the pixel electrode and a common electrode provided on the transparent substrate. The electronic ink is thus sandwiched between the common electrode and the pixel electrodes. The electronic ink comprises multiple microcapsules of about 10 to 50 microns. Each microcapsule comprises positively charged white particles and negatively charged black particles suspended in a fluid. When a positive voltage is applied to the pixel electrode with respect to the common electrode, the white particles move to the side of the microcapsule directed to the transparent substrate, and the display element appears white to a viewer. Simultaneously, the black particles move to the pixel electrode at the opposite side of the microcapsule where they are hidden from the viewer. By applying a negative voltage to the pixel electrode with respect to the common electrode, the black particles move to the common electrode at the side of the microcapsule directed to the transparent substrate, and the display element appears dark to a viewer. When the electric field is removed, the display device remains in the acquired state and exhibits a bi-stable character. This electronic ink display with its black and white particles is particularly useful as an electronic book.

Grey scales can be created in the display device by controlling the amount of particles that move to the common electrode at the top of the microcapsules. For example, the energy of the positive or negative electric field, defined as the product of field strength and time of application, controls the amount of particles which move to the top of the microcapsules.

From the non-pre-published patent applications in accordance to applicants docket referred to as PHNL020441 and PHNL030091 which have been filed as European patent applications 02077017.8 and 03100133.2 it is known to minimize the image retention by using preset pulses (also referred to as the shaking pulse). Preferably, the shaking pulse comprises a series of AC-pulses, however, the shaking pulse may comprise a single preset pulse only. The pre-published patent applications are directed to the use of shaking pulses, either directly before the drive pulses, or directly before the reset pulses. PHNL030091 further discloses that the picture quality can be improved by extending the duration of the reset pulse which is applied before the drive pulse. An over-reset pulse is added to the reset pulse, the over-reset pulse and the reset pulse together, have an energy which is larger than required to bring the pixel into one of two limit optical states. The duration of the over-reset pulse may depend on the required transition of the optical state. Unless explicitly mentioned, for the sake of simplicity, the term reset pulse may cover both the reset pulse without the over-reset pulse or the combination of the reset pulse and the over-reset pulse. By using the reset pulse, the pixels are first brought into one of two well defined limit states before the drive pulse changes the optical state of the pixel in accordance with the image to be displayed. This improves the accuracy of the grey levels.

For example, if black and white particles are used, the two limit optical states are black and white. In the limit state black, the black particles are at a position near to the transparent substrate, in the limit state white, the white particles are at a position near to the transparent substrate.

The drive pulse has an energy to change the optical state of the pixel to a desired level which may be in-between the two limit optical states. Also the duration of the drive pulse may depend on the required transition of the optical state.

The non-prepublished patent application PHNL030091 discloses in an embodiment that the shaking pulse precedes the reset pulse. Each level (which is one preset pulse) of the shaking pulse has an energy (or a duration if the voltage level is fixed) sufficient to release particles present in one of the extreme positions, but insufficient to enable said particles to reach the other one of the extreme positions. The shaking pulse increases the mobility of the particles such that the reset pulse has an immediate effect. If the shaking pulse comprises more than one preset pulse, each preset pulse has the duration of a level of the shaking pulse. For example, if the shaking pulse has successively a high level, a low level and a high level, this shaking pulse comprises three preset pulses. If the shaking pulse has a single level, only one preset pulse is present.

The complete voltage waveform which has to be presented to a pixel during an image update period is referred to as the drive voltage waveform. The drive voltage waveform usually differs for different optical transitions of the pixels.

### SUMMARY OF THE INVENTION

The driving of the electrophoretic display in accordance with the present invention differs from the driving disclosed in the non-prepublished patent applications in that groups of lines of pixels are selected at the same time during identical portions of the drive voltage waveform. The portions are identical if they have the same level or the same sequence of levels which occur during the same period in time. The lines can only be selected in groups if the selected pixels associated with a same data electrode have to receive the same level, and if this is true for all data electrodes. It is not required that all data electrodes have to supply the same levels to all selected pixels. In the prior art, the lines of pixels (usually the rows) are selected one by one.

A first aspect of the invention provides a drive circuit for an electrophoretic display as claimed in claim 1. A second aspect of the invention provides an electrophoretic display as claimed in claim 9. A third aspect of the invention provides a display apparatus as claimed in claim 20. A fourth aspect of the invention provides a method of driving an electrophoretic display as claimed in claim 21. Advantageous embodiments of the invention are defined in the dependent claims.

Before explaining how the electrophoretic display in accordance with the first aspect of the invention operates and which advantages are reached, first a possible driving method of the display is elucidated to provide a framework.

In electrophoretic displays it is important to be able to achieve accurate intermediate optical states. In the example that the electrophoretic display is an E-ink display which comprises microcapsules with black and white oppositely charged particles, the intermediate optical states are grey levels. Generally, the intermediate optical states or the grey levels are created by applying voltage pulses during a specific time period. The accuracy of the intermediate optical states in electrophoretic displays is strongly influenced by the image history, dwell time, temperature, humidity, lateral inhomogeneity of the electrophoretic foil, etc.

Accurate intermediate optical states can be obtained by using a transition matrix driving scheme wherein the actual duration and/or level of the drive pulse for a particular pixel is determined based on the drive history of this pixel.

Accurate intermediate optical states can also be obtained by using a rail-stabilized approach, wherein the intermediate optical states are always achieved starting from the well defined extreme optical states (the two rails), which are a reference black state or a reference white state if black and white particles are used in the E-ink display. A driving method which uses a single reset voltage pulse preceding the drive pulse appeared to perform very well. The reset pulse causes the pixel to change its optical state from an arbitrary intermediate optical state to one of the extreme optical states, the drive pulse causes the pixel to change from the extreme optical state to the desired intermediate optical state. The use of a shaking pulse preceding the reset pulse and/or the drive pulse further improves the accuracy of the intermediate optical states.

The pulse sequence of the drive voltage waveform may comprise successively: first shaking pulses, the reset pulse, second shaking pulses, and the drive pulse. The reset pulse should last longer than the time required for switching the electrophoretic material from its present state to one of the extreme states. The first and second shaking pulses reduce the dwell time and image history effects and thus reduce the image retention and increase the intermediate optical state accuracy. In this driving method, both the first and second shaking pulses are present in every drive voltage waveform, thus independent on the optical transition to be reached.

As in such a driving method, the drive voltage waveform comprises many serially arranged pulses, the duration of an image update period is quite long. It has to be noted that each one of the levels of the pulses has to last a frame period. In a frame period, all the lines (usually the rows) of the display are selected (addressed) one by one during a line period to allow the drive voltages to be supplied to the pixels of the selected row. For example, if the line period lasts 30 microseconds, this results in a frame period of, for example, 18 milliseconds if the display has 600 rows. Consequently, the drive voltage waveform may last 0.5 to 1 second, which has the drawback in that the refresh of an image is clearly visible, and the display of moving video is impractical. Especially, the optical flicker induced by shaking pulses with long frame duration becomes visible. It is also difficult to generate accurate intermediate optical states using a simple driver with a limited number of voltage levels.

If the duration of the frame period is decreased in an attempt to decrease the duration of the image update period, this results in a shorter duration of the line period. This has the drawback that the pixels may not have sufficient time to fully charge up to the voltage applied. The minimal duration of the line time is thus limited.

Thus, in the prior art, the lines of pixels, which usually are the rows of the matrix display, are selected one by one to be able to supply the data signals via the data electrodes, which are usually the column electrodes, to the pixels of the selected line. In this manner it is possible to address each pixel separately, which means that it is possible to individually determine the drive voltage waveform supplied to a pixel. It has to be noted that the drive voltage waveforms supplied to pixels of an electrophoretic display may differ dependent on the optical transition of a pixel. For example for a particular optical transition a relatively short reset pulse may suffice, while for an other optical transition a longer reset pulse may be required. This means that for each pixel it should be possible to supply the appropriate reset pulse, and thus each pixel should be separately addressable.

In the drive circuit in accordance with the first aspect of the invention, the select driver selects groups of lines of the pixels at a same time. During the selection of the group of lines, the data driver supplies the data to the selected groups of pixels via data electrodes. Thus, all the pixels of the group of lines of pixels which are associated with the same data electrode receive the same data signals. It is not required that all the pixels of the group of lines receive the same data signals, it suffices if the pixels in the same column receive the same data signals for each one of the columns.

In accordance with the invention, for portions of the drive voltage waveform which are equal for all the pixels of each column of the group of rows, at least a subset of these rows is selected at the same time. It is not relevant to the invention which pulses are actually present in the drive voltage waveform. For example, the reset pulse may not be present, or only a single shaking pulse may be present. What counts is that the drive waveform has a common portion which is the same for the pixels in a column. The common part has to occur during the same period in time for all columns, but may have different levels for different columns. Different levels for different columns may, for example occur if inversion shaking is applied wherein the voltage levels supplied to adjacent columns have opposite polarity.

For example, if the electrophoretic matrix display comprises 600 rows it is possible to select groups of 10 rows at the same time. The period of time during which one of the groups is selected is referred to as the group select period. The total number of groups is 60. These 60 groups are selected one by one, a complete cycle of selecting all rows last 60 group select periods which is referred to as the total select period. In one limit approach, the 10 rows of the groups are selected during one line period, thus, the group select period equals a single line period required to be able to fully change the pixels. Now, only one tenth of a frame period is required to select all the pixels, and thus the duration of the image update period decreases. In this example, the total select period wherein the complete display is selected lasts 60 line periods which is one tenth of the original select time which lasts one frame period. Thus, the image refresh rate increases. In another limit approach, each group of 10 lines is selected during 10 lines, thus, the selection of the 60 groups takes the originally required frame period. Now, the refresh rate is not decreased, but the power dissipation decreases because no signal changes are required during 10 lines.

In yet another limit situation wherein during a portion of the drive voltage waveform all the pixels may receive the same voltage it would be possible to select all the lines of pixels or rows at the same time. Instead of the frame period, only a line period would be required to address all the pixels. This would maximally increase the refresh rate, however this might cause too large capacitive currents. It is also possible to select all the rows at the same time during a longer period in time than one line period. Thus, even if it is possible to select all the rows at the same time, it might be more practical to select groups of rows which comprise a subset of the total number of rows.

The decreased duration of the frame period is particularly useful for image update sequences with shaking pulses to reduce the optical flicker induced by the shaking pulses. A decrease of the power consumption is particularly useful in portable applications wherein the life time of a battery is very important.

In an embodiment in accordance with the invention as defined in claim 2, the lines of pixels (also referred to as rows) of the group of rows are all selected during a group select period. During the group select period, the voltage drive waveform has a predetermined level. For example, if the shaking pulse is aligned in time to occur for the group of lines during a same period of time, each one of the levels of the shaking pulse is supplied to the data electrodes during the group select period. If the shaking pulse comprises two levels, during the first level, the groups of rows are selected successively, each during the group select period until all lines have been selected. Then, during the second level the groups of rows are selected successively, again each during the group select period until all lines have been selected. The group select period may vary between a single line time up to the complete frame time if the group of lines comprises all lines.

In an embodiment in accordance with the invention as defined in claim 3, the group of rows is selected during the group select period which has a duration longer then a single line period but shorter than the frame period. This has the advantage that a compromise is reached between the increase of the refresh rate and the decrease of the power consumption of the electrophoretic matrix display. For example if groups of ten rows are selected each during two line periods, only one fifth of a frame period is required to select all the pixels, and the power consumption will decrease because the same data is supplied to the group of ten rows during two line periods.

In an embodiment in accordance with the invention as defined in claim 4, the selection of the group of rows at the same time during a line period is used to decrease the image update period as elucidated earlier.

In an embodiment in accordance with the invention as defined in claim 5, the controller controls the select driver to select a predetermined number of groups of lines. Each group of lines comprises a predetermined number of lines of pixels. The predetermined number of groups of lines and the predetermined number of lines are selected such that all the lines of pixels of the display are covered. For example, if the select electrodes extend in the row direction, and the display has 600 rows, the predetermined number of groups may be selected to be 30 which gives rise to the predetermined number of lines per group which is 20. The duration of the group select period during which one of the groups is selected may vary between a single line period and the frame period divided by the predetermined number of groups. The duration of the single line period is limited by the minimal time required by the pixels to sufficiently charge or discharge due to a new level of the drive waveform. The frame period is defined as the time period required to select the rows of the display one by one, and thus is equal to the number of rows of the display multiplied by the line period.

If the group select time is one line period, all the rows of the display are selected in a total select period which is equal to the predetermined number of groups multiplied by the line period. This total select period is smaller than the frame period, and thus the refresh rate of the display is increased. If the group select time is equal to frame period divided by the predetermined number of groups, the total select period is equal to the frame period. The refresh rate is not increased, but the power consumption decreases. In in between situations, both the refresh rate is increased and the power consumption is decreased.

In an embodiment in accordance with the invention as defined in claim 6, only a single group of lines is selected which comprises all the lines of pixels of the display. In fact, this drive scheme is equal to the one elucidated with respect to claim 5 when the predetermined number of groups is one.

In an embodiment in accordance with the invention as defined in claim 7, the display is operated in two display modes. In one display mode, the complete display is updated, in the other display mode only a sub-area of the display is updated. This is for example relevant if information in a window overlays background information.

If the complete display is updated, the lines of the display are divided in n groups of lines. Instead of selecting the lines one by one, the groups of lines are selected one by one to select all the pixels of the display and to update the information displayed by the pixels. If a group of lines is selected, this means that all the lines of the group are selected at the same time during the group select period. This is only possible during portions of the drive waveforms which are identical for each one of the data electrodes. Thus different data electrodes may receive different drive waveforms, but the waveform supplied to a particular data electrode should be valid for all the selected pixels of the data electrode.

If the sub-area of the display is updated, the lines of the display within the sub-area are divided in groups of lines. The lines of a group of lines within the sub-area are selected at the same time, while a drive voltage waveform is supplied to each of the data electrodes which is identical for all the selected pixels of each data electrode. Or said differently, during the whole group select period during which the lines of a group of lines is selected, each one of the data electrodes has to supply a voltage level that is required by the selected pixels associated with the data electrode.

Thus both during the update of the complete display and during the update of the sub-area of the display, the lines of pixels are selected in groups if for each one of the data electrodes the same voltage level has to be supplied to selected pixels associated with one of the data electrodes. This drive scheme can be used to optimize the refresh rate and/or the power consumption during both a complete update of the display or during the update of the sub-area only. It is possible to select different optimizations for updating the complete display and for updating the sub-area. For example, during a complete update, if the refresh rate is not very important, the groups may be used to minimize the power consumption. For example, the groups of lines are selected as long as possible, such that all groups are selected once during the frame period. And, during a sub-area update, if the refresh rate is very important, the groups may be used to minimize the image update periods. For example, as many lines are selected at the same time during an as short time as possible, preferably during one line period.

During the update of the information displayed in the sub-area, it is possible to supply the same voltage level to all the data electrodes during the portions of the drive waveforms which are identical for each one of the data electrodes. For example, if the shaking pulses are aligned in time in different drive voltage waveforms required to obtain different optical transitions, it is possible to provide each one of the levels (pre-pulses) of the shaking pulses to all the data electrodes at the same time. Thus, also the pixels outside the sub-area receive the shaking pulse. This may cause a drift of intermediate optical states on the display outside the window. It is also possible to supply the shaking pulse to only the data electrodes associated to the sub-area and to supply hold voltages to the data electrodes which are not associated with the sub area.

In an embodiment in accordance with the invention as defined in claim 8, the complete display is addressed using the same drive scheme as in the embodiment in accordance with the invention as defined in claim 7. The lines are selected in groups and the same voltage on the data electrode is supplied to the selected pixels associated with the data electrode. But now, in the second display mode, the lines of pixels of the sub-area are selected one by one. This enables to selectively only update the pixels within the sub-area. No pulse levels are supplied to data electrodes not associated with the sub-area, thus, the optical states outside the sub-area are not influenced. This has the advantage that it is not required to update equal level optical transitions. For example, white to white transitions needs not be updated within the sub-area Also no shaking pulses have to be supplied for these equal optical state transitions.

In an embodiment in accordance with the invention as defined in claim 10, the shaking pulse occurs during a same shaking time period for all pixels. This is realized even although the drive pulse may have a duration which depends (for example, linearly) on a difference between optical states of the pixel before and after an image update period. As discussed earlier, the shaking pulse may comprise a single preset pulse or a series of preset pulses. Now it is possible, during the common shaking pulse, to select all the lines of pixels at the same time. However this may cause very high capacitive currents. It is therefore preferred to still select groups of lines of pixels at the same time. For example 10 lines of pixels are selected at the same time. The time which is gained in this manner may be completely used to decrease the image update time. It is also possible to increase the time the group of lines is selected to lower the dissipation. A combination of these two effects is also possible.

If the shaking pulse is supplied to all the pixels at the same time (or to groups of lines of pixels), the power efficiency will increase because, it is possible, for each preset pulse, to select all the lines (or the group of lines) simultaneously and to supply the same data signal level to all the selected pixels. The effect of capacitances between pixels and electrodes will decrease. Further, as all the pixels may be selected simultaneously, the duration of the level(s) of the shaking pulse need not be the standard frame period. The duration of the level(s) of the shaking pulse may become much shorter than the standard frame period thus shortening the image update period and reducing the power consumption. For example, a single line select period may suffice. It is also possible to use more than a single line select period to supply the levels of the shaking pulse to improve the picture quality.

Thus, in this embodiment in accordance with the invention, the drive voltage waveform is deliberately adapted to create larger portions which are equal for all the pixels. This increases the potential to shorten the image update period and/or to decrease the power consumption. The drive voltage waveform may also be referred to as drive voltage.

In an embodiment in accordance with the invention as defined in claim 11, the shaking pulse occurs during a same shaking time period for all pixels. This is realized even although the reset pulse and/or the drive pulse may have a duration which depends (for example, linearly) on a difference between optical states of the pixel before and after an image update period. As discussed earlier, the shaking pulse may comprise a single preset pulse or a series of preset pulses. Again, now it is possible, during the common shaking pulse, to select all or groups of the lines of pixels at the same time.

If the shaking pulse which precede the reset pulse or which occurs in-between the reset pulse and the drive pulse is supplied to all the pixels at the same time (or to groups of lines of pixels), the power efficiency will increase because it is possible, for each preset pulse, to select all the lines (or the group of lines) simultaneously and to supply the same data signal level to all the selected pixels. Further, again, as all the pixels may be selected simultaneously, the duration of the level(s) of the shaking pulse need not be the standard frame period. The duration of the level(s) of the shaking pulse may become much shorter than the standard frame period thus shortening the image update period and reducing the power consumption.

In an embodiment in accordance with the invention as claimed in claim 12, the duration of the reset pulse depends for each pixel on the optical transition to be made.

A too long reset pulse has the drawback that the particles will be pressed together too much in one of the extreme positions, which makes it difficult to move them away from this extreme position. Thus, it is an advantage when the reset pulse varies with the optical state transitions of the pixels. For example, if black and white particles are used, two intermediate optical states may be defined: dark grey and light grey. The optical state transitions are now: black to dark grey, black to light grey, black to white, white to light grey, white to dark grey, white to black, dark grey to black, dark grey to light grey, dark grey to white, light grey to black, light grey to dark grey, light grey to white.

By way of example, if the shaking pulse is to immediately precede the reset pulse, and the drive pulses start all at the same instant, the time of occurrence of the shaking pulse will depend on the duration of the reset pulse and thus will be different for pixels which have different transitions of their optical states. Thus, during a particular frame period some pixels must receive a shaking pulse while other pixels should not receive a shaking pulse. To be able to only supply the shaking pulse to the pixels which should receive it, each level of the shaking pulse has to be available during a complete frame period during which all the rows of pixels have to be selected one by one. In the present invention, the shaking pulse occurs during the same period in time for all pixels. It is thus possible to select all the pixels in a single line period and to supply the same drive voltage to all the pixels, although the duration of the reset pulse is different for pixels which have different optical transitions.

If the reset pulse has a duration less than its maximum duration, due to the shaking pulse which always occurs during the same shaking period, a not yet used time period exists between the shaking pulse and the reset pulse, or between the reset pulse and the drive pulse, or both. If this not yet used time period (the dwell time) becomes too large a disturbance of the desired optical state of the pixel may occur.

In an embodiment in accordance with the invention as claimed in claim 13, both first and second shaking pulses are generated. The first shaking pulse is present for all pixels during the same first shaking period which precedes the reset period in which the reset pulse is applied. The second shaking pulse is present for all pixels during the same second shaking period which precedes the drive period during which the drive pulse is applied. This second shaking pulse further improves the reproduction quality of the picture to be displayed.

In an embodiment in accordance with the invention as claimed in claim 14, an over-reset is used wherein the duration of the reset pulse is somewhat longer than required to better move the particles to the extreme positions. It is possible to select from a limited number of possible durations of the reset pulse. However, preferably, a sufficient number of durations of the reset pulses is available to obtain a comparable over-reset effect for different optical transitions.

In an embodiment in accordance with the invention as claimed in claim 15, the duration of the reset pulses is proportional to the distance required for the particles to move. As now no over-reset but a proportional reset is applied, the particles can easily be moved after the reset pulse as they are not packed together more than required.

In an embodiment in accordance with the invention as claimed in claims 16 and 17, an extra shaking pulse is introduced in the not yet used time period which exists between the shaking pulse and the reset pulse, or between the reset pulse and the drive pulse, respectively. The extra shaking pulse may comprise a single pulse or a plurality of pulses.

In an embodiment in accordance with the invention as claimed in claim 12, the preset pulses of the extra shaking pulse have an energy content which is lower than the energy content of the preset pulses of the first and second shaking pulses because the effect of dwell-time is small and the optical disturbance caused by the extra shaking pulses should be small.

These and other aspects of the invention are apparent from and will be elucidated with reference to the embodiments described hereinafter.

### BRIEF DESCRIPTION OF THE DRAWINGS

In the drawings:

FIG. 1 shows diagrammatically a cross-section of a portion of an electrophoretic display,

FIG. 2 shows diagrammatically a picture display apparatus with an equivalent circuit diagram of a portion of the electrophoretic display,

FIG. 3 shows voltages across a pixel in different situations wherein over-reset and various sets of shaking pulses are used,

FIG. 4 shows voltages across a pixel if the shaking periods occur during the same time periods and no over-reset is used,

FIG. 5 shows voltages across a pixel wherein a further shaking pulse is present preceding the reset pulse if the reset pulse does not occur during the complete reset period,

FIG. 6 shows voltages across a pixel wherein further shaking pulses are present trailing the reset pulses if the reset pulses do not occur during the complete reset periods,

FIG. 7 shows signals occurring during a frame period,

FIG. 8 shows a block diagram of an electrophoretic display with a driving circuit for selecting groups of lines,

FIG. 9 shows schematically a display apparatus with a driver and a bi-stable display, and

FIG. 10 shows different areas on the display screen.

### DETAILED DESCRIPTION OF THE PREFERRED EMBODIMENT

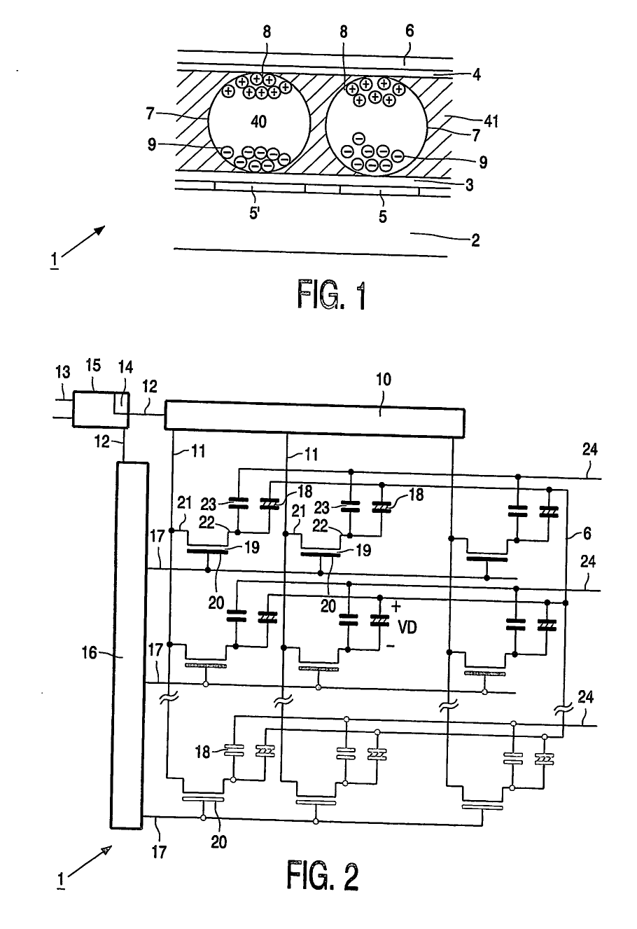

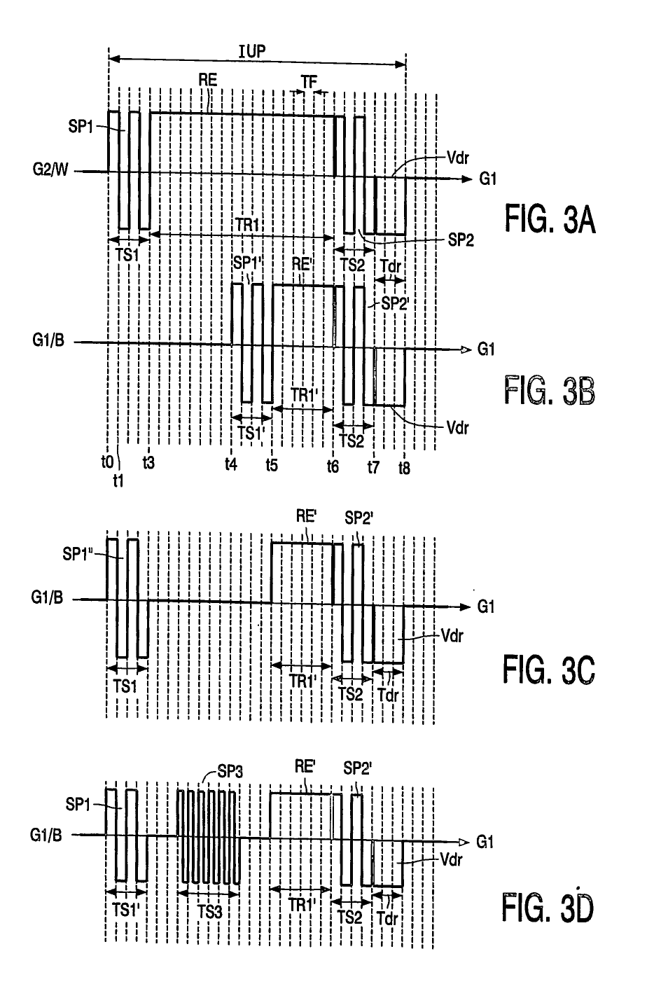

FIG. 1 shows diagrammatically a cross-section of a portion of an electrophoretic display, which for example, to increase clarity, has the size of a few display elements only. The electrophoretic display comprises a base substrate 2, an electrophoretic film with an electronic ink which is present between two transparent substrates 3 and 4 which, for example, are of polyethylene. One of the substrates 3 is provided with transparent pixel electrodes 5, 5′ and the other substrate 4 with a transparent counter electrode 6. The counter electrode 6 may also be segmented. The electronic ink comprises multiple microcapsules 7 of about 10 to 50 microns. Each microcapsule 7 comprises positively charged white particles 8 and negatively charged black particles 9 suspended in a fluid 40. The dashed material 41 is a polymer binder. The layer 3 is not necessary, or could be a glue layer. When the pixel voltage VD across the pixel 18 (see FIG. 2) is supplied as a positive drive voltage Vdr (see, for example, FIG. 3) to the pixel electrodes 5, 5′ with respect to the counter electrode 6, an electric field is generated which moves the white particles 8 to the side of the microcapsule 7 directed to the counter electrode 6 and the display element will appear white to a viewer. Simultaneously, the black particles 9 move to the opposite side of the microcapsule 7 where they are hidden from the viewer. By applying a negative drive voltage Vdr between the pixel electrodes 5, 5′ and the counter electrode 6, the black particles 9 move to the side of the microcapsule 7 directed to the counter electrode 6, and the display element will appear dark to a viewer (not shown). When the electric field is removed, the particles 8, 9 remain in the acquired state and the display exhibits a bi-stable character and consumes substantially no power. Electrophoretic media are known per se from e.g. U.S. Pat. No. 5,961,804, U.S. Pat. No. 6,1120,839 and U.S. Pat. No. 6,130,774 and may be obtained from E-ink Corporation.

FIG. 2 shows diagrammatically a picture display apparatus with an equivalent circuit diagram of a portion of the electrophoretic display. The picture display device 1 comprises an electrophoretic film laminated on the base substrate 2 provided with active switching elements 19, a row driver 16 and a column driver 10. Preferably, the counter electrode 6 is provided on the film comprising the encapsulated electrophoretic ink, but, the counter electrode 6 could be alternatively provided on a base substrate if a display operates based on using in-plane electric fields. Usually, the active switching elements 19 are thin-film transistors TFT. The display device 1 comprises a matrix of display elements associated with intersections of row or select electrodes 17 and column or data electrodes 11. The row driver 16 consecutively selects the row electrodes 17, while the column driver 10 provides data signals in parallel to the column electrodes 11 to the pixels associated with the selected row electrode 17. Preferably, a processor 15 firstly processes incoming data 13 into the data signals to be supplied by the column electrodes 11.

The drive lines 12 carry signals which control the mutual synchronisation between the column driver 10 and the row driver 16.

The row driver 16 supplies an appropriate select pulse to the gates of the TFT's 19 which are connected to the particular row electrode 17 to obtain a low impedance main current path of the associated TFT's 19. The gates of the TFT's 19 which are connected to the other row electrodes 17 receive a voltage such that their main current paths have a high impedance. The low impedance between the source electrodes 21 and the drain electrodes of the TFT's allows the data voltages present at the column electrodes 11 to be supplied to the drain electrodes which are connected to the pixel electrodes 22 of the pixels 18. In this manner, a data signal present at the column electrode 11 is transferred to the pixel electrode 22 of the pixel or display element 18 coupled to the drain electrode of the TFT if the TFT is selected by an appropriate level on its gate. In the embodiment shown, the display device of FIG. 1 also comprises an additional capacitor 23 at the location of each display element 18. This additional capacitor 23 is connected between the pixel electrode 22 and one or more storage capacitor lines 24. Instead of TFTs, other switching elements can be used, such as diodes, MIMs, etc.

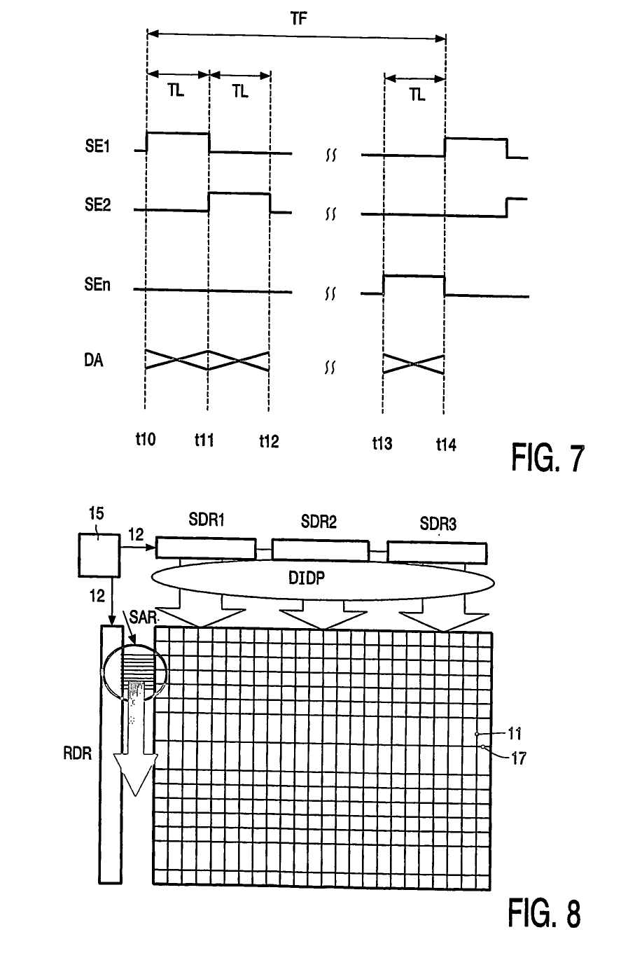

FIG. 3 shows voltages across a pixel in different situations wherein over-reset is used. By way of example, FIG. 3 are based on an electrophoretic display with black and white particles and four optical states: black B, dark grey G1, light grey G2, white W. FIG. 3A shows an image update period IUP for a transition from light grey G2 or white W to dark grey G1. FIG. 3B shows an image update period IUP for a transition from dark grey G1 or black B to dark grey G1. The vertical dotted lines represent the frame periods TF (which usually last 20 milliseconds), the line periods TL occurring within the frame periods TF are not shown in FIGS. 3 to 6. The line periods TL are illustrated in FIG. 7.

In both FIG. 3A and FIG. 3B, the pixel voltage VD across a pixel 18 comprises successively first shaking pulses SP1, SP1′, a reset pulse RE, RE′, second shaking pulses SP2, SP2′ and a drive pulse Vdr. The driving pulses Vdr occur during the same drive period TD which lasts from instant t7 to instant t8. The second shaking pulses SP2, SP2′ immediately precede the driving pulses Vdr and thus occur during a same second shaking period TS2. The reset pulse RE, RE′ immediately precede the second shaking pulses SP2, SP2′. However, due to the different duration TR1, TR1′ of the reset pulses RE, RE′, respectively, the starting instants t3 and t5 of the reset pulses RE, RE′ are different. The first shaking pulses SP1, SP1′ which immediately precede the reset pulses RE, RE′, respectively, thus occur during different first shaking periods in time TS1, TS1′, respectively.

In the embodiment in accordance with the invention, the second shaking pulses SP2, SP2′ occur for every pixel 18 during a same second shaking period TS2. This enables to select the duration of this second shaking period TS2 much shorter as shown in FIGS. 3A and 3B. For clarity, each one of levels of the second shaking pulses SP2, SP2′ is present during the standard frame period TF. In fact, in accordance with this embodiment of the invention, now, during the second shaking period TS2, the same voltage levels can be supplied to all the pixels 18. Thus, instead of selecting the pixels 18 line by line, it is now possible to select all the pixels 18 at once, and only a single line select period TL (see FIG. 7) suffices per level. Thus, in the embodiment in accordance with the invention shown in FIGS. 3A and 3B, the second shaking period TS2 only needs to last four line periods TL instead of four standard frame periods TF. However, it is still possible to only select groups of lines (not comprising all the lines) of pixels at the same time to lower the capacitive currents.

Alternatively, it is also possible to change the timing of the drive signals such that the first shaking pulses SP1 and SP1′ are aligned in time, the second shaking pulses SP2 are then no longer aligned in time (not shown). Now the first shaking period TS1 can be much shorter.

The driving pulses Vdr are shown to have a constant duration, however, the drive pulses Vdr may have a variable duration.

If the drive method shown in FIGS. 3A and 3B is applied to the electrophoretic display, outside the second shaking period TS2, the pixels 18 have to be selected line by line by activating the switches 19 line by line. The voltages VD across the pixels 18 of the selected line are supplied via the column electrodes 11 in accordance with the optical state the pixel 18 should have. For example, for a pixel 18 in a selected row of which pixel the optical state has to change from white W to dark grey G1, a positive voltage has to be supplied at the associated column electrode 11 during the frame period TF starting at instant t0. For a pixel 18 in the selected row of which pixel the optical state has to change from black B to dark grey G1, a zero voltage has to be supplied at the associated column electrode during the frame period TF lasting from instants t0 to t1.

FIG. 3C shows a waveform which is based on the waveform shown in FIG. 3B. This waveform of FIG. 3C causes the same optical transition. The difference is that the first shaking pulses SP1′ of FIG. 3B are now shifted in time to coincide with the shaking pulses SP1 of FIG. 3A. The shifted shaking pulses SP1′ are indicated by SP1″. Thus, now, independent on the duration of the reset pulse RE, also all the shaking pulses SP1, SP1″ occur during the same shaking period TS1. This has the advantage that independent of the optical transition, both the same shaking pulses SP1, SP1″ and SP2, SP2′ can be supplied to all pixels 18 simultaneously. Thus both during the first shaking period TS1 and the second shaking period TS2 it is not required to select the pixels 18 line by line. Whilst in FIG. 3C the shaking pulses SP1″ and SP2′ have a predetermined high or low level during a complete frame period, it is possible to use shaking pulses SP1″ and SP2′ lasting one or more line periods TL (see FIG. 7). In this manner, the image update time may be maximally shortened. Further, due to the selection of all lines at the same time and providing a same voltage to all columns, during the shaking periods TS1 and TS2, the capacitances between neighboring pixels and electrodes will have no effect. This will minimize stray capacitive currents and thus dissipation. Even further, the common shaking pulses SP1, SP1″ and SP2, SP2′ enable implementing shaking by using structured counter electrodes 6.

A disadvantage of this approach is that a small dwell time is introduced (between the first shaking pulse period TS1 and the reset period TR1′). Dependent on the electrophoretic display used, this dwell time should not become longer than, for example, 0.5 seconds.

FIG. 3D shows a waveform which is based on the waveform shown in FIG. 3C. To this waveform third shaking pulses SP3 are added which occur during a third shaking period TS3. The third shaking period TS3 occurs between the first shaking pulses SP1 and the reset pulse RE′, if this reset pulse RE′ does not have it maximum length. The third shaking pulses SP3 may have a lower energy content than the first shaking pulses SP1 to minimize the visibility of the shaking. It is also possible that the third shaking pulses SP3 are a continuation of the first shaking pulses SP1. Preferably, the third shaking pulses SP3 fill up the complete period in time available between the first shaking period TS1′ and the reset period TR1′ to minimize the image retention and to increase the grey scale accuracy. With respect to the embodiment in accordance with the invention shown in FIG. 3C, the image retention is further reduced and the dwell time is massively reduced.

Alternatively, it is possible that the reset pulse RE′ occurs immediately after the first shaking pulses SP1 and the third shaking pulses occur between the reset pulse RE′ and the second shaking pulses SP2′.

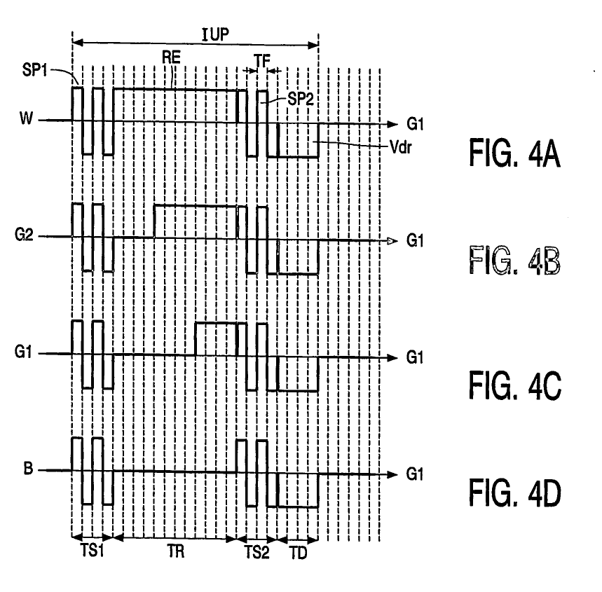

The embodiments in accordance with the invention shown in FIG. 3 are based on an over-reset. The image retention can be further improved by using reset pulses RE, RE′ which have a length which is proportional to the distance the particles 8, 9 have to move between the pixel electrode 5, 5′ and the counter electrode 6. Embodiments in accordance with the invention which are based on such proportional reset pulses are shown in FIGS. 4 to 6.

FIG. 4 shows voltages across a pixel if the shaking periods occur during the same time periods and no over-reset is used. FIG. 4 shows drive waveforms for all optical transitions to dark grey G1.

FIG. 4A shows a waveform required to change the optical state of the pixel 18 from white W to dark grey G1. FIG. 4B shows a waveform required to change the optical state of the pixel 18 from light grey G2 to dark grey G1. FIG. 4C shows a waveform required to keep the optical state of the pixel 18 dark grey G1. FIG. 4D shows a waveform required to change the optical state of the pixel 18 from black B to dark grey G1. For other transitions similar drive waveforms are required. For example, for the transition from white W to black B, portions of the waveform of FIG. 4A can be used, but with Vdr=0V.

In all FIG. 4, the first shaking pulses SP1 occur during the same first shaking period TS1, the second shaking pulses SP2 occur during the same second shaking period TS2, and the driving pulse Vdr occurs during the same drive period TD. The driving pulses Vdr may have different durations. The reset pulse RE has a length which depends on the optical transition of the pixel 18. For example, in a pulse width modulated driving, the full reset pulse width TR is required for resetting the pixels 18 from white W to black B or W to dark grey G1, see FIG. 4A. For resetting the pixels 18 from light grey G2 to black B or G2 to dark grey G1, only ⅔ of the duration of this full reset pulse width TR is required, see FIG. 4B. For resetting the pixels 18 from dark grey G1 to black B or G1 to dark grey, only ⅓ of the duration of this full reset pulse width TR is required, see FIG. 4C. For resetting the pixels 18 from black B to dark grey G1, no reset pulse is required, see FIG. 4D.

These waveforms are also useful when the known transition matrix based driving methods are used in which previous images are considered in determining the impulses (time×voltage) for a next image. Alternatively, these waveforms are also useful when the electrophoretic material used in the display is less sensitive to the image history and/or dwell time.

Thus, to conclude, independent on the duration of the reset pulse RE, the first shaking pulses SP1 and the second shaking pulses SP2 can be supplied to all the pixels 18 simultaneously, which has the advantages mentioned before.

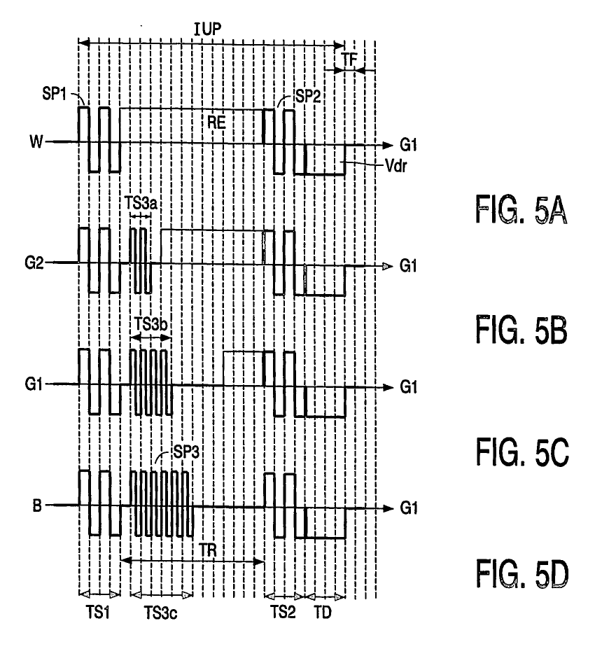

FIG. 5 shows voltages across a pixel wherein further shaking pulses are present preceding the reset pulse if the reset pulse does not occur during the complete reset period. FIG. 5A is identical to FIG. 4A, and FIGS. 5B to 5D are based on FIGS. 4B to 4D, respectively. In FIGS. 5B to 5D, third reset pulses SP3 are added during the period of time TS3a, TS3b, TS3c, respectively, which occurs in-between the first shaking pulses SP1 and the reset pulse RE. These additional third reset pulses SP3 may differ from the first and second shaking pulses SP1 and SP2 in terms of pulse length and/or pulse height depending on the required image quality. Generally, the energy in these additional shaking pulses SP3 may be lower than the energy in the first shaking pulses SP1 because the dwell time effect is small and the optical disturbance should be minimized. The amount of shaking in the different sequences is preferably proportional to the time space available between the first shaking pulses SP1 and the reset pulse RE. More preferably, the time period between the first shaking pulses SP1 and the reset pulse RE is fully filled with the additional shaking pulses SP3 to minimize the image retention and to increase the grey scale accuracy. Again, the advantage of the embodiments in accordance with the invention as elucidated with respect to FIG. 4 is maintained, whilst the degree of image retention and the dwell time effect can be further reduced by the additional shaking.

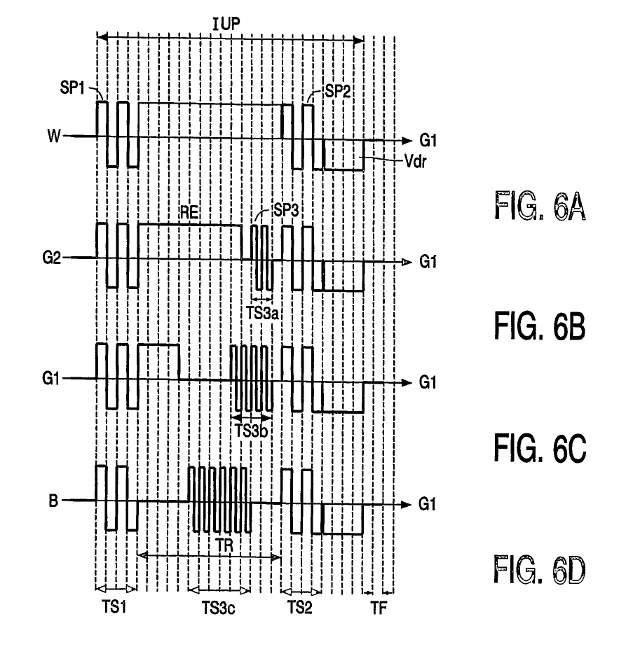

FIG. 6 shows voltages across a pixel wherein further shaking pulses are present trailing the reset pulse if the reset pulse does not occur during the complete reset period. FIG. 6A is identical to FIG. 5A. In FIGS. 6B to 6D, which are based on FIGS. 5B to 5D, respectively, the position of the reset pulse RE and the additional third shaking pulses SP3 is interchanged such that the reset pulse RE now precedes the additional shaking pulses SP3. Preferably, the reset pulse RE starts immediately after completion of the first shaking pulses SP1. The additional shaking pulses SP3 may cover part of the period in time or the complete period in time between the first and second shaking pulses SP1, SP2 which is not covered by the reset pulse RE. The use of the additional shaking pulses SP3 improves the grey scale accuracy.

FIG. 7 shows signals occurring during a frame period. Usually, each frame period TF indicated in FIGS. 3 to 6 comprises a number of line periods TL which is equal to a number of rows of the electrophoretic matrix display. In FIG. 7, one of the successive frame periods TF is shown in more detail. This frame period TF starts at the instant t10 and lasts until instant tl4. The frame period TF comprises n line periods TL. The first line period TL lasts from instant t10 to t11, the second line period TL lasts from instant t11 to t12, and the last line period TL lasts from instant t13 to t14.

Usually, during the frame period TF, the rows are selected one by one by supplying appropriate select pulses SE1 to SEn to the rows. A row may be selected by supplying a pulse with a predetermined non-zero level, the other rows receive a zero voltage and thus are not selected. The data DA is supplied in parallel to all the pixels 18 of the selected row. The level of the data signal DA for a particular pixel 18 depends on the optical state transition of this particular pixel 18.

Thus, if different data signals DA may have to be supplied to different pixels of a column, the frame periods TF shown in FIGS. 3 to 6 comprise the n line or select periods TL. However, if the first and second shaking pulses SP1 and SP2 occur during the same shaking periods TS1 and TS2, respectively, for all the pixels 18 simultaneously, it is possible to select all the lines of pixels 18 simultaneously and it is not required to select the pixels 18 line by line. Thus, during the frame periods TF shown in FIGS. 3 and 6 wherein common shaking pulses are used, it is possible to select all the pixels 18 in a single line period TL by providing the appropriate select pulse to all the rows of the display. Consequently, these frame periods may have a significantly shorter duration (one line period TL, or a number of line periods less than n, instead of n) than the frame periods wherein the pixels 18 associated with the columns may receive different data signals. Thus, the invention is useful not only in situations wherein all the pixels have to receive the same voltage, but also during situations wherein all the pixels of each of the columns of pixels have to receive a same voltage, while the voltages supplied to different columns may be different.

By way of example, the addressing of the display is elucidated in more detail with respect to FIG. 3C. At the instant to a first frame period TF of an image update period IUP starts. The image update period IUP ends at the instant t8.

The first shaking pulses SP1″ are supplied to all the pixels 18 during the first shaking period TS1 which lasts from instant t0 to instant t3. During this first shaking period TS1, during each frame period TF, all (or a group of) the lines of pixels 18 are selected simultaneously during at least one line period TL and the same data signals are supplied to all columns of the display. The level of the data signal is shown in FIG. 3C. For example, during the first frame period TF lasting from instant t0 to t1, a high level is supplied to all the pixels. During the next frame period TF starting at instant t1, a low level is supplied to all the pixels. A same reasoning is valid for the common second shaking period TS2.

The duration of the reset pulse RE, RE′ may be different for different pixels 18 because the optical transition of different pixels 18 depends on the image displayed during a previous image update period IUP and the image which should be displayed at the end of the present image update period IUP. For example, a pixel 18 of which the optical state has to change from white W to dark grey G1, a high level data signal DA has to be supplied during the frame period TF which starts at instant t3, while for a pixel 18 of which the optical state has to change from black B to dark grey G1, a zero level data signal DA is required during this frame period. The first non-zero data signal DA to be supplied to this last mentioned pixel 18 occurs in the frame period TF which starts at the instant t4. In the frames TF wherein different data signals DA may have to be supplied to different pixels 18, the pixels 18 have to be selected row by row.

Thus, although all the frame periods TF in FIGS. 3 to 6 are indicated by equidistant vertical dotted lines, the actual duration of the frame periods may be different. In frame periods TF in which different data signals DA have to be supplied to the pixels 18, usually the pixels 18 have to be selected row by row and thus n line select periods TL are present. In frame periods TF in which the same data signals DA have to be supplied to all the pixels 18, the frame period TF may be as short as a single line select period TL. However, it is possible to select all the lines simultaneously during more than a single line select period TL. It is also possible to select successively sub-groups of the lines, each sub-group is selected during one or several line select periods.

FIG. 8 shows a block diagram of an electrophoretic display with a driving circuit for selecting groups of lines.

The data drivers SDR1, SDR2, SDR3 supply the drive voltage waveforms VD to the data electrodes 11. The drive voltage waveforms VD comprise portions which are equal for all pixels 18 associated with a particular data electrode 11 independent on the optical transition to be made by the pixels 18. With equal portions is meant, the portions of the drive voltage waveform VD which during a particular period of time have the same pulse level. The pulses in the drive voltage waveforms VD which are equal are referred to as the data independent driving pulses DIDP.

FIG. 8 schematically shows that during the occurrence of data independent driving pulses DIDP, the select driver RDR selects the select electrodes 17 in groups SAR at a time. For example, if the electrophoretic matrix display comprises 600 select electrodes 17 (and thus 600 rows of pixels 18), the select driver RDR may select 10 select electrodes 17 during the same time period. Preferably, the groups SAR comprise adjacent select electrodes 17. In one frame period TF, all the rows are selected. Thus, in this example, the frame period TF is now the number of rows divided by ten times the line select period TL (also referred to as row select period) instead of the number of rows times the row select period TL. Thus at the same row select period TL, the frame period TF lasts now one tenth of the time required if the rows have to be selected one by one. The arrow starting at the group of selected rows SAR indicates that the selected groups of rows moves along the direction of the data electrodes 11.

In portions of the drive voltage waveform VD which are data dependent (thus which may be different for different pixels 18 in the same column because different optical state transitions are required), the rows are selected one by one and the frame period TF has the original, relatively long, duration.

The controller 15 controls the timing of the select driver RDR and the data drivers SDR1 to SDR3 according to whether the portion of drive voltage waveform VD is data independent or not. The controller 15 detects where the data independent driving pulses DIDP occur, or is instructed about the periods in time where these data independent driving pulses DIDP occur. During portions of the drive voltage waveform VD which are data dependent, the known drive sequence is performed during which the rows are selected one by one and the data is supplied to each selected row of pixels 18. During portions of the drive voltage waveform VD which are data independent, the controller 15 instructs the data drivers SDR1 to SDR3 to provide the data to the data electrodes 11. The data on a particular data electrode 11 may differ from the data on another one of the data electrodes 11. The data is kept available during the frame period TF which has a duration allowing all the groups of rows SAR to be selected such that all the rows are selected. The controller 15 instructs the select driver RDR to select the groups of rows SAR one after another until all the rows have been selected. Now the data drivers SDR1 to SDR3 provide the data for the next frame period TF. If during the next frame period TF still data independent drive pulses DIDP are present, still the rows are selected in groups SAR, etc. Instead of the three data drivers SDR1 to SDR3, any other suitable number of data drivers may be used. However, if the data driver is integrated, the dissipation in the integrated circuit and the number of connection pins available may give rise to more than one data driver.

The number of rows in a group SAR may be selected dependent on the application. For example, if a minimal frame period TF and thus a minimal image update period IUP is required, all the rows are selected during a single line period TL, thus only a single group of rows SAR exists. Although a lower average power consumption is reached, the peak power will become very large because of the very large capacitive drive currents in the display. In a compromise between shortening the frame period TF and preventing large drive currents, for example, 10 rows are selected at the same time during one tenth of the original frame period TF. In a compromise between shortening the frame period TF and decreasing the power consumption, for example, 10 rows are selected at the same time during half of the original frame period TF. Now, the 10 rows are selected during 5 line periods TL instead of 1 line period TL. This would result in a 5 times lower clock rate in the entire display and hence in a considerable power saving.

The selection of groups of rows SAR can be performed in different ways. The controller 15 may instruct the select driver RDR for each group of rows SAR to select a particular group of rows SAR by indicating the numbers of the rows to be selected. The complete timing is performed by the controller 15. Alternatively, the controller 15 may only indicated the start of a particular frame period TF and whether in this particular frame period TF the rows have to be selected in groups SAR or not. The select driver RDR comprises timing circuits (not shown) which select the rows one by one starting from the start of the particular frame period TF if the controller 15 indicates that data dependent data pulses are present on the data electrodes 11. Or, the select driver RDR selects the row in successive groups SAR when the controller 15 indicates that data independent data pulses DIDP are present on the data electrodes 11.

The driving method in accordance with the invention is particularly important for driving schemes containing shaking pulses SP1, SP2. At present, the length of the preset pulses of the shaking pulse SP1, SP2 is determined by the frame period TF required for selecting the rows one by one. If the shaking pulse SP1, SP2 occurs (or is made to occur) during a same period of time TS1, TS2 in the drive voltage waveform VD independent of the optical transition a particular pixel 18 has to undergo, the duration of the frame periods TF during this common shaking pulse SP1, SP2 is reduced. The optical disturbance caused by the shaking pulses SP1, SP2 will become less.

Although the selection of groups is discussed with respect to updating the complete display, the same approach can be used to select groups of lines within a sub-area W1 of the display. The lines of pixels 18 which can be selected are then restricted to the lines within the sub-area.

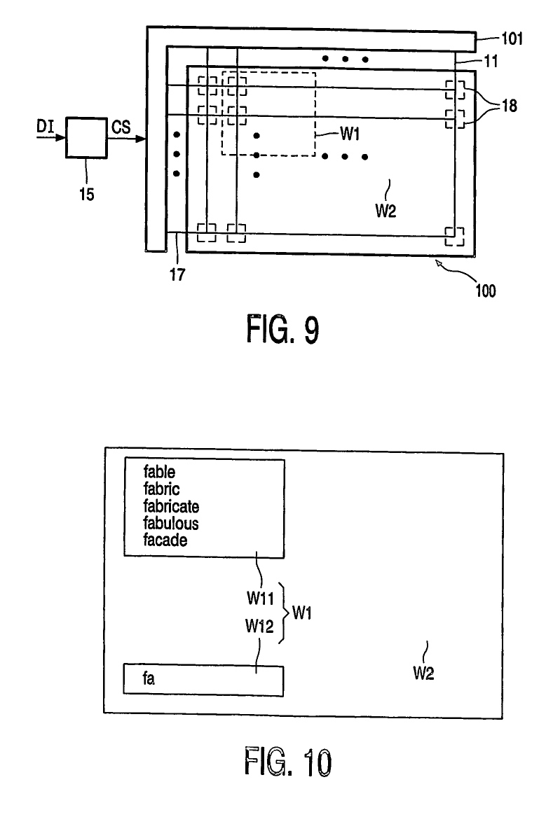

FIG. 9 shows schematically a display apparatus with a driver 101 and a bi-stable matrix display 100. The matrix display 100 comprises pixels 18 associated with intersections of the select electrodes 17 and data electrodes 11. Usually, the select electrodes 17 extend in the row direction and are also referred to as row electrodes and the data electrodes 11 extend in the column direction and are also referred to as column electrodes. Usually, the bi-stable matrix display 100 is an active matrix display which comprises transistors 19 (shown in FIG. 2, not shown in FIG. 9) which are controlled by select voltages on the select electrodes 17. A particular line or row of pixels 18 of which the control inputs are connected with a particular one of the select electrodes 17 is selected if the driver 101 (the select driver 16 of FIG. 5) supplies a select voltage to this particular one of the select electrodes 17 to obtain conductive transistors 19. The data voltages on the data electrodes 11 are supplied to this selected row of pixels 18 via the conductive transistors 19. The other rows of pixels 18 associated with the other select electrodes 17 are not selected if the driver 101 supplies select voltages to obtain non-conductive transistors 19. The data voltages on the data electrodes 11 are substantially unable to influence the voltage across the pixels 18 of these non-selected rows of pixels 18 because the transistors 19 are non-conductive.

FIG. 9 indicates a first area W1 on the display screen of the matrix display 100 and a second area W2 on the display screen. By way of example only, the first area W1 is a rectangular window. The first area W1 is further referred to as sub-area W1 to indicate that the first area W1 is smaller than the complete display area of the display 100. The second area W2 may indicate the complete display area of the display 100, or the area of the display 100 outside the sub-area W1.

Usually, the optical state of the pixels 18 of the complete display 100 is updated during an image update period IUP. Usually, during an image update period IUP, the driver circuit 101 selects the rows of pixels 18 one by one. The driver circuit 101 further supplies drive waveforms to the pixels 18 of the selected row in parallel via the data electrodes 11. As the drive waveforms usually comprise a sequence of voltage levels, the drive waveforms are also referred to as drive voltage waveforms.

The drive waveform for a particular pixel 18 depends on the optical transition to be made by this pixel 18. This is illustrated for an electrophoretic display with respect to FIGS. 3 to 6. Because usually all the pixels 18 of the display 100 have to be updated, and the optical transition of each pixel 18 is arbitrary, the lines of the display have to be selected one by one. The arbitrary optical transition of each pixel 18 means that each pixel 18 may receive one of a group of possible drive waveforms. Usually for different optical transitions different drive waveforms are required. As it is arbitrary, dependent on the image to be displayed, which one of the drive waveforms has to be supplied to which pixels 18, the longest drive waveform determines the image update period IUP. The longest drive waveform comprises a sequence of levels which has the longest duration. It has to be noted that the drive waveforms shown in FIGS. 3 to 6 comprise a sequence of frame periods TF. During each frame period TF all the pixels 18 have to be updated (in fact, every pixel 18 receives a drive waveform required for obtaining the desired optical transition of the pixel 18). Thus, during each fame period TF, all the rows of pixels 18 have to be selected row by row and the driver 101 supplies the appropriate level of the drive voltage waveforms via the data electrodes 11 in parallel to each selected row of pixels 18. A row of pixels 18 should be selected during a minimal time to allow the capacitive pixels 18 to be charged sufficiently to the appropriate level. The duration of the frame period TF is determined by this minimal time, usually referred to as line period, and the number of rows which has to be selected. Thus, the duration of the drive waveform depends on the drive waveform required for a particular optical transition and on the duration of the frame periods TF for each one of the levels of the drive waveform.

However, in an embodiment in accordance with the invention, when during a first display mode the complete display is updated, during portions of the drive voltage waveforms which are identical for each pixel 18, thus have the same level and occur during a same period in time, the lines of pixels 18 are selected in groups during a group select period. For example, in the drive waveforms shown in FIG. 3, the shaking pulses SP2 and SP2′ all occur for each pixel 18 during a same shaking period TS2. Thus, during this shaking period TS2, it is possible for each level (or pre-pulse) of the shaking pulse SP2, SP2′ to supply this level to all the pixels 18 or to sub-groups of the pixels 18 at the same time. If a group of lines of pixels 18 is selected at the same time, it is possible to increase the refresh rate because the duration the level has to be supplied becomes shorter than the frame period TF. It is also possible to decrease the power consumption as during a longer time the voltage level across the pixels 18 does not vary. Or, it is possible to find a desired compromise between the increase of the refresh period and the lower power consumption. For other portions of the drive waveforms, the lines of pixels 18 have to be selected one by one to be able to supply different levels to different pixels during a same frame period TF.

If in a second display mode, only the pixels 18 associated with a sub-area W1 of the display 101 have to be updated; only the rows of pixels 18 associated with the sub-area W1 have to be selected during the image update period IUP. Because less then all the rows of pixels 18 have to be selected, the frame period TF (number of lines to be selected multiplied by the line period) will be shorter and thus the duration of a drive waveform will be shorter. It is thus possible to update the image within the sub-area W1 with an image update period IUP shorter than the image update period IUP required for the second area W2 wherein all the rows of pixels 18 have to be selected. Consequently, the refresh rate of the information displayed in the sub-area W1 is higher than the refresh rate of the information displayed in the second area W2.

In the second display mode, the pixels 18 within the sub-area W1 may be updated by selecting the lines of pixels 18 associated with the sub-area W1 one by one during a complete image update period of the sub-area. This is especially relevant if different drive waveforms have to be supplied to pixels 18 to perform different optical transitions. Thus, only select electrodes 17 within the sub-area W1 are selected. The data electrodes which are not associated with the sub-area W1 receive a hold voltage which usually is substantially zero. Although, this drive scheme within the sub-area W1 does not provide a possibility to increase the refresh rate of the information displayed within the sub-area W1 or to lower the power consumption during the update of the information within the sub-area W1, the optical state of pixels 18 outside the sub-area W1 is not disturbed and the drive waveforms used in the sub-area W1 are not required to have identical portions.

Alternatively, in the second display mode, the pixels 18 within the sub-area W1 may be updated be selecting groups of lines of pixels 18 associated with the sub-area W1 for those portions of the different drive waveforms which are identical, thus which have the same levels and which occur during the same period in time. For the other portions of the drive waveforms, the lines of pixels 18 still have to be selected one by one. Thus, again, only select electrodes 17 within the sub-area W1 are selected. The lines of pixels 18 within the sub-area W1 are selected in groups during identical portions of the drive waveform which occur during a same period of time. During these portions, the time require to select all the lines of pixels 18 may be shorter than the frame period TF to increase the refresh rate of the information displayed within the sub-area W1. Alternatively, the time required selecting all the lines of pixels 18 may be selected to be still the frame period TF. The power consumption decreases. It is also possible to select a compromise between the refresh rate increase and the power consumption decrease when the information in the sub-area W1 is updated.

Although, this drive scheme within the sub-area W1 does provide a possibility to increase the refresh rate of the information displayed within the sub-area W1 or to lower the power consumption during the update of the information within the sub-area W1, the optical state of pixels 18 outside the sub-area W1 may be disturbed when during the identical portion of the drive waveforms which occur during the same period of time, the associated levels of the drive waveforms are supplied to all selected pixels 18, thus also to the pixels 18 outside the sub-area W1. This would for example occur if the drive waveforms shown in FIGS. 4C to 6C are used. During both the shaking pulses SP1 and SP2 the lines of pixels 18 within the sub-area W1 are selected in groups. The pixels 18 of the selected lines outside the sub-area W1 have to keep their optical state and thus may receive the drive waveforms as shown in FIGS. 4C to 6C. As during the shaking pulses SP1 and SP2 the lines of pixels 18 are selected in groups, also the pixels 18 outside the sub-area W1 are selected in groups and receive the same shaking levels as the pixels 18 within the sub-area W1. These shaking pulses may deteriorate the performance outside the sub-area W1. Therefore, preferably, a hold voltage is supplied to the data electrodes associated with pixels outside the sub-area W1.

FIG. 10 shows different areas on the display screen. The sub-area W1 now comprises two areas W11 and W12. The second area W2 covers the area of the display screen not covered by the first area W11, W12, or the total area of the display screen. The area W12 is a rectangular area showing a sequence of characters inputted by the user. In this example, the user inputted the string far. The area W11 is a rectangular area showing a listing of words starting with the string fa. The area W2 shows background information, which is, for example, a comedy book page with grey pictures and text consisting the word “fabulous”, which is not known to the user. The user starts typing fa in W12 and more words starting with fa are listed in W11. The areas W11 and W12 need not be rectangular, but this will complicate the addressing of the pixels 18 of the areas.

It is important that the user gets a prompt reaction when he inputs the characters to be displayed in the window W12. In fact the user expects an immediate response on its typing action. However, the image update period IUP required for updating a complete electrophoretic display with 600 rows of pixels 18 is in the order of 0,6 to 1,1 seconds and thus far too long for an immediate response. But, if in response to a detected user input, only the information in the sub-area W12 is updated, only a few rows of pixels 18 need to be addressed during the image update period IUP and the image update period IUP will become shorter and a higher refresh rate is obtained, and thus a faster response on the input. Thus, preferably, further the selection of groups of lines of pixels 18 within the sub-area W1 is used to minimize the duration of the image update period IUP and to maximize the refresh rate of the information displayed during the first display mode in the sub-area W1 only. If the information displayed on the complete display is updated, and if the refresh rate for this complete update is not very important, the selection of groups of lines during the first display mode is optimized to decrease the power consumption to increase the battery life time. The refresh rate of the complete display may be less relevant if only back ground information is displayed on the complete display, or text which requires a relatively long time to be read.

Such driving schemes are impossible in displays which do not have the bi-stable behavior of an electrophoretic display. These other displays, such as for example, liquid crystal displays, are unable to display information for a relatively long period in time unchanged without updating the pixel voltages.

It should be noted that the above-mentioned embodiments illustrate rather than limit the invention, and that those skilled in the art will be able to design many alternative embodiments without departing from the scope of the appended claims.

For example, the second shaking pulses SP2 need not be present. A shorter image update period IUP and/or a lower power consumption is already reached if only one set of shaking pulses SP1 or SP2 is present and this set occurs during a same shaking period TS1 or TS2. Although in the Figures, is referred to shaking pulses SP1 or SP2 which comprise several levels or preset pulses, it is possible that the shaking pulses SP1 or SP2 comprise a single level or preset pulse only. In these examples, a constant energy in each preset pulse is shown. Alternatively, the energy in each preset pulse can be variable.

It is possible to use driving schemes wherein the reset pulse RE is not present and a direct grey-to-grey level transition (or more general, an intermediate optical state to another intermediate state transition) is realized, preferably based on a transition matrix approach. The higher frame rate obtained in an embodiment according to the invention is used to reduce the optical flicker introduced by the shaking pulses SP1, SP2, and also to reduce the total image update time IUP.

Although in the drive waveforms shown in FIGS. 3 to 6 all levels are indicated to have a duration of the frame period TF, actually this duration may be shorter than the frame period TF if groups of lines are selected during identical portions of the drive waveforms. The identical drive waveforms are shown to be the shaking pulses SP1, SP2, and the selection of groups of lines of pixels 18 occurs during each one of the levels of the shaking pulses SP1, SP2. Alternatively, if no shaking pulses are present, during other levels which are identical for all the pixels associated with the same data electrode, the lines of pixels 18 may be selected in groups. It might also occur that besides the shaking pulses, other levels are present which are identical for all the pixels associated with the same data electrode. Also during these levels, the lines of pixels 18 may be selected in groups.

The invention is also applicable to color electrophoretic displays.

Any driving schemes using, for example, voltage modulation or pulse width modulation or a combination of both may be used. Electrode structures with top and bottom electrodes, honeycomb or other structures may be used.

In the claims, any reference signs placed between parenthesis shall not be construed as limiting the claim. The word “comprising” does not exclude the presence of other elements or steps than those listed in a claim. The invention can be implemented by means of hardware comprising several distinct elements, and by means of a suitably programmed computer. In the device claim enumerating several means, several of these means can be embodied by one and the same item of hardware.

1. A drive circuit for an electrophoretic matrix display with a plurality of pixels (18), the drive circuit comprising:
a select driver (16) for selecting lines of the pixels (18),
a data driver (10) for supplying drive waveforms (VD) to the selected pixels (18) via data electrodes (5, 5′), and
a controller (15) for controlling the select driver (16) to select a group of lines of pixels (18) at the same time during a portion of the drive waveforms (VD) being identical for at least all selected pixels (18) of each one of the data electrodes (5, 5′).

2. A drive circuit as claimed in claim 1, wherein the controller (15) is arranged for controlling the select driver (16) to select the group of lines of pixels (18) during a group select period during which the drive voltage waveform (VD) has a predetermined level.

3. A drive circuit as claimed in claim 2, wherein the controller (15) is arranged for controlling the select driver (16) to select the group of lines during the group select period which has a duration longer than a line period (TL) but smaller than a frame period (TF), a duration of the frame period (TF) being defined as the time required to select all lines of pixels (18) of the electrophoretic matrix display one by one, the line period (TL) being the frame period (TF) divided by a number of lines of the electrophoretic matrix display.

4. A drive circuit as claimed in claim 1, wherein the controller (15) is arranged for controlling the select driver (16) to select said group of lines during a line period (TL) being a frame period (TF) divided by a number of lines of the electrophoretic matrix display, to decrease a duration of an image update period (IUP), a duration of the frame period (TF) being defined as the time required to select all lines of pixels (18) of the electrophoretic matrix display one by one.

5. A drive circuit as claimed in claim 2, wherein the controller (15) is arranged for controlling the select driver (16) to select a predetermined number of groups of lines of pixels (18) each comprising a predetermined number of lines of pixels (18), the predetermined number of groups of lines of pixels (18) and the predetermined number of lines of pixels (18) of each of the groups of lines of pixels (18) being selected to cover all lines of pixels (18) of the electrophoretic matrix display, each one of the groups of lines of pixels (18) being selected during the group select period which has a duration selected in the interval: a single line period (TL) to a single frame period (TF) divided by the predetermined number of the groups of lines of pixels (18), the line period (TL) being the frame period (TF) divided by a number of lines of the electrophoretic matrix display, a duration of the frame period (TF) being defined as the time required to select all lines of pixels (18) of the electrophoretic matrix display one by one.

6. A drive circuit as claimed in claim 2, wherein the controller (15) is arranged for controlling the select driver (16) to select the group of lines comprising all lines of pixels (18) of the electrophoretic matrix display during the group select period which has a duration selected in the interval: a single line period (TL) to a single frame period (TF), the line period (TL) being the frame period (TF) divided by a number of lines of the electrophoretic matrix display, a duration of the frame period (TF) being defined as the time required to select all lines of pixels (18) of the electrophoretic matrix display one by one.

7. A drive circuit as claimed in claim 1, wherein the controller (15) is arranged for controlling
during a first display mode wherein all pixels (18) are updated, the select driver (16) to select successively n groups of lines of pixels (18), the lines of pixels (18) of each one of said n groups of lines being selected at the same time during the portion of the drive voltage waveforms (VD) being identical for at least all the selected pixels (18) of each one of the data electrodes (5, 5′), and
during a second display mode wherein only the pixels (18) in a sub-area (W1) of the display are updated, the select driver (16) to select the group of lines of pixels (18) at the same time within the sub-area (W1) only, the group of lines of pixels (18) being selected during a portion of the drive voltage waveforms (VD) being identical for at least all the selected pixels (18) of each one of the data electrodes (5, 5′).

8. A drive circuit as claimed in claim 1, wherein the controller (15) is arranged for controlling
during a first display mode wherein all pixels (18) are updated, the select driver (16) to select successively n groups of lines of pixels (18), the lines of pixels (18) of each one of said n groups of lines being selected at the same time during a portion of the drive voltage waveforms (VD) being identical for at least all the selected pixels (18) of each one of the data electrodes (5, 5′),
during a second display mode wherein only the pixels (18) in a sub-area of the display are updated, the select driver (16) to select the lines of pixels (18) within the sub-area (W1) only, the lines of pixels (18) within the sub-area (W1) being selected one by one.

9. An electrophoretic display comprising a drive circuit as claimed in claim 1.

10. An electrophoretic display as claimed in claim 9, wherein the pixels (18) comprise an electrophoretic material (8, 9) comprising charged particles, each one of the pixels (18) being associated with a first electrode (6) and one of the data electrodes (5, 5′), the data driver (10) being arranged for presenting the drive voltage waveforms (VD) between the first electrode (6) and the data electrodes (5, 5′), wherein the charged particles are able to occupy two limit positions between the first electrode (6) and the second electrode (5) in response to the drive voltage waveform (VD), and wherein the controller (15) is arranged for controlling the data driver (10) to supply the drive voltage waveform (VD) comprising during an image update period (IUP):
a drive pulse (Vdr) having a level/and or duration in accordance with an optical state to be reached by the associated one of the pixels (18), and
a first shaking pulse (SP1) occurring during a same first shaking time period (TS1) for all the pixels (18) of the selected group of lines of pixels (18), the first shaking pulse (SP1) comprising at least one preset pulse having an energy sufficient to release particles present in one of the limit positions but insufficient to enable said particles to reach the other one of the limit positions.

11. An electrophoretic display as claimed in claim 10, wherein the controller (15) is arranged for controlling the data driver (10) to supply the drive voltage waveform (VD) comprising:
during an image update period (IUP) successively: (i) a reset pulse (RE) for enabling said particles to substantially occupy one of the limit positions, and (ii) the drive pulse (Vdr), and
the first shaking pulse (SP1) preceding the reset pulse (RE) or occurring between the reset pulse (RE) and the drive pulse (Vdr).

12. An electrophoretic display as claimed in claim 11, wherein the data driver (10) is arranged for generating the reset pulse (RE) having a duration depending on a difference between optical states of the pixel (18) before and after an image update period (IUP).

13. An electrophoretic display as claimed in claim 11, wherein the data driver (10) is arranged for applying the first shaking pulse preceding the reset pulse (RE) and for further generating a second shaking pulse (SP2) in-between the reset pulse (RE) and the drive pulse (Vdr), wherein the second shaking pulse (SP2) occur during a same second shaking time period (TS2) for all pixels (18) of the group of lines of pixels.

14. An electrophoretic display as claimed in claim 11, wherein the data driver (10) is arranged for generating the reset pulse (RE) with a duration longer than required to have the particles occupying one of the extreme positions.

15. An electrophoretic display as claimed in claim 11, wherein the data driver (10) is arranged for generating the reset pulse (RE) with a duration substantially proportional with a distance required for the particles to move from a present position to one of the extreme positions.

16. An electrophoretic display as claimed in claim 11, wherein, if the reset pulse (RE) has a duration shorter than a maximum duration, the data driver (10) is arranged for generating a third shaking pulse (SP3) during at least part of a third shaking period (TS3) occurring in-between the first shaking pulse (SP1) and the reset pulse (RE).

17. An electrophoretic display as claimed in claim 11, wherein, if the reset pulse (RE) has a duration shorter than a maximum duration, the data driver (10) is arranged for generating a third shaking pulse (SP3) during at least part of a third shaking period (TS3) occurring in-between the reset pulse (RE) and the drive pulse (Vdr).

18. An electrophoretic display as claimed in claim 16, wherein the data driver (10) is arranged for generating the third shaking pulse (SP3) having a lower energy content than the first shaking pulse (SP1).

19. An electrophoretic display as claimed in claim 17, wherein the data driver (10) is arranged for further generating a second shaking pulse (SP2) in-between the third shaking pulse (SP3) and the drive pulse (Vdr), wherein the second shaking pulse (SP2) occurs during a same second shaking time period (TS2) for all pixels (18) of a group of lines of pixels.

20. A display apparatus comprising an electrophoretic display as claimed in claim 1.

21. A method of driving an electrophoretic matrix display comprising a plurality of pixels (18), the method comprising:
selecting (16) lines of the pixels (18),
supplying (10) drive voltage waveforms (VD) to each one of the selected pixels (18) via data electrodes (5, 5′), and
controlling (15) the select driver (16) to select a group of lines of pixels (18) at a same time during portions of the drive voltage waveforms (VD) which for each of the data electrodes (5, 5,) are equal for at least all the pixels (18) being associated with the same one of the data electrodes (5, 5′).

22. A method as claimed in claim 18 wherein the pixels (18) comprise an electrophoretic material (8, 9) comprising charged particles, each one of the pixels (18) being associated with a first electrode (6) and one of the data electrodes (5, 5′),
the step of supplying (10) presenting the drive voltage waveforms (VD) between the first electrode (6) and the data electrodes (5, 5′), wherein the charged particles are able to occupy two limit positions between the first electrode (6) and the second electrode (5) in response to the drive voltage waveform (VD), and wherein the the step of controlling (15) controls the step of supplying (10) to supply the drive voltage waveform (VD) comprising:
during an image update period (IUP) successively: (i) a reset pulse (RE) for enabling said particles to substantially occupy one of the limit positions, and (ii) a drive pulse (Vdr) having a level/and or duration in accordance with an optical state to be reached by the associated one of the pixels (18), and
a first shaking pulse (SP1) occurring during a same first shaking time period (TS1) for all the pixels (18) of the selected group of lines of pixels (18), the first shaking period (TS1) preceding the reset pulse (RE) or occurring between the reset pulse (RE) and the drive pulse (Vdr), the first shaking pulse (SP1) comprising at least one preset pulse having an energy sufficient to release particles present in one of the extreme positions but insufficient to enable said particles to reach the other one of the extreme positions.
